(19) United States
(12) Patent Application Publication
(10) Pub. No.: US 2013/0145272 A1
(43) Pub. Date: Jun. 6, 2013

(54) SYSTEM AND METHOD FOR PROVIDING AN INTERACTIVE DATA-BEARING MIRROR INTERFACE

(71) Applicant: The New York Times Company, New York, NY (US)

(72) Inventors: Matthew T. Boggie, Brooklyn, NY (US); Brian J. House, Brooklyn, NY (US); Alexis J. Lloyd, Brooklyn, NY (US); Michael A. Zimbalist, Montclair, NJ (US)

(73) Assignee: THE NEW YORK TIMES COMPANY, New York, NY (US)

(21) Appl. No.: 13/679,324

(22) Filed: Nov. 16, 2012

Related U.S. Application Data
(60) Provisional application No. 61/561,685, filed on Nov. 18, 2011.

(51) Int. Cl. G06F 3/0487

(52) U.S. Cl. CPC G06F 3/0487
USPC 715/728

(57) ABSTRACT

An interactive interface of an embodiment of the present invention comprises a mirror surface; a sensor configured to receive an input from a user; a processor communicatively coupled to the sensor; the processor configured to identify a user identification based on the input, retrieve user specific content associated with the user identification; and identify one or more interactions with the user, wherein the processor comprises a speech processor and a video processor; and an output configured to display content associated with the user identification and responsive to the interactions on the mirror surface.

### CROSS REFERENCE TO RELATED APPLICATIONS

This application claims priority to U.S. Provisional Application 61/561,685, filed on Nov. 18, 2011. The contents of this priority application are incorporated herein by reference herein in its entirety.

### FIELD OF THE INVENTION

The present invention relates to a system and method for providing a data-bearing interface and more particularly to an interactive data-bearing mirror interface for providing timely and useful information personalized to the user.

### BACKGROUND OF THE INVENTION

Mobile devices and tablets are becoming more mainstream and useful to all types of users. Just about anyone can access a wealth of information provided by an array of useful applications and tools. The current trend is to provide portable devices that are mobile and easy to use. However, as screens become smaller and flatter, information is condensed onto smaller interfaces and oftentimes images and content are removed or reformatted to fit information on a smaller platform. Current devices are thus limited by the display of information, the size of the screen and the ways a user can interact with the information and device itself.

### SUMMARY OF THE INVENTION

An interactive interface of an embodiment of the present invention comprises a mirror surface; a sensor configured to receive an input from a user; a processor communicatively coupled to the sensor; the processor configured to identify a user identification based on the input, retrieve user specific content associated with the user identification; and identify one or more interactions with the user, wherein the processor comprises a speech processor and a video processor; and an output configured to display content associated with the user identification and responsive to the interactions on the mirror surface.

### BRIEF DESCRIPTION OF DRAWINGS

FIG. 1 is an exemplary method for implementing an interactive data-bearing interface, according to an embodiment of the present invention;

FIG. 2 is an exemplary system for implementing an interactive data-bearing interface, according to an embodiment of the present invention;

FIG. 3 is an exemplary display illustrating an interactive data-bearing interface, according to an embodiment of the present invention;

FIG. 4 is an exemplary display illustrating an interactive data-bearing interface, according to an embodiment of the present invention;

FIG. 5 is an exemplary display illustrating a weather feature on an interactive data-bearing interface, according to an embodiment of the present invention;

FIG. 6 is an exemplary display illustrating a health monitoring feature on an interactive data-bearing interface, according to an embodiment of the present invention;

FIG. 7 is an exemplary display illustrating a content display on an interactive data-bearing interface, according to an embodiment of the present invention;

FIG. 8 is an exemplary display illustrating a video messaging on an interactive data-bearing interface, according to an embodiment of the present invention; and

FIG. 9 is an exemplary interface illustrating a clothing application, according to an embodiment of the present invention.

### DETAILED DESCRIPTION OF EXEMPLARY EMBODIMENT(S)

Embodiments of the present invention include a data-bearing mirror comprising motion-sensing, voice recognition, touch-screen, and/or RFID technology to detect physical cues from a user or from objects. The data-bearing mirror may be connected to a network, such as the internet, and may display a wide variety of content to a user.

In various exemplary embodiments, the mirror's screen may comprise a semi-reflective glass surface, enabling users to view a normal mirror reflection as well as overlaid, high-contrast graphics. The data-bearing mirror's screen may comprise a standard, e.g., LCD panel, affixed with a semi-transparent piece of glass. Reflection may occur in areas that are dark on the LCD panel, where the mirror screen may be fully reflective when the LCD panel is off. Light from the LCD panel may pass through the semi-transparent pieces of glass and be visible to a user.

The LCD panel may be coupled to a computer or other processor, which may be mounted behind the LCD panel and semi-transparent piece of glass. It should be appreciated that the components of the computer may be arranged to minimize the depth of the mirror. The components of the computer may be water-cooled to allow for minimal ventilation and a slimmer profile for the data-bearing mirror.

A user may interact with the data-bearing mirror in a number of ways, including, for example, voice commands, gestures, object recognition and/or facial recognition. The data-bearing mirror may comprise motion-sensing technology. For example, the data-bearing mirror may incorporate a system using a camera, infrared projector and/or microchip to track the movement of objects and individuals in three dimensions. Other motion-sensing configurations may include an RGB camera, a depth sensor, a multi-array microphone and/or other sensors to provide full-body 3D motion capture, facial recognition, and voice recognition capabilities. A microphone array may facilitate acoustic source localization and ambient noise suppression when a user is interacting with the data-bearing mirror.

The depth sensor may include an infrared laser projector combined with a CMOS sensor, which may capture video data in three-dimensions. In various embodiments, the range of the depth sensor may be adjustable, and software may be implemented to automatically calibrate the sensor based on the user's physical environment.

The data-bearing mirror may incorporate gesture recognition, facial recognition, object recognition and/or voice recognition. In various alternative embodiments, the data-bearing mirror may be configured to recognize and track more than one user simultaneously.

Various types of content may be displayed on the mirror's screen. For example, the user may, by accessing a website over its network connection, display the current weather forecast to a user. Such information may be automatically presented to the user, or it may be presented based on a user request. For example, a user may state: “Mirror. Show me the weather.” The data-bearing mirror may recognize this voice command (utilizing voice-recognition software), and display the current forecast to the user. In other exemplary embodiments, certain gestures (e.g., a hand wave in a certain direction) may queue the mirror to display a certain type of content (e.g., the weather forecast).

The data-bearing mirror may be configured to react to objects shown to it by recognizing the objects and displaying relevant information. For example, a user may try on a particular garment of clothing, which may be captured by a camera mounted on the data-bearing minor. The data-bearing mirror may process information related to that particular garment, and provide information such as the garment's price, other available colors, origin of materials and components, etc.

Objects interacting with the data-bearing mirror's surface, such as beams of light or thrown objects, may trigger displayed that could either enhance the reflection power of the mirror (e.g., an illustration of incident and reflected angles of light) or create the illusion of a portal (e.g., a ball thrown at the mirror may trigger a display of a sphere receding into the distance, rendering the appearance of a cavity “behind” the data-bearing mirror's display).

Other media inputs may also be incorporated into the data-bearing mirror. For example, the data-bearing mirror may be configured to display an image captured from a networked camera, webcam and/or other device. Again, this content may displayed on the mirror automatically or pursuant to certain user requests. In at least one exemplary embodiment, a camera may be fixed outside of a building, and a user may view images captured by that camera on the data-bearing mirror's screen.

Any number of media inputs may be displayed on the minor, including internet and intranet connected websites. Media inputs may be automatically displayed to the user based on user preferences or random sequences. In an exemplary embodiments, newspaper headlines may be presented to the data-bearing mirror via a website in certain intervals. If a user would like to read the full-story that corresponds to the headline, the user may prompt the mirror to display the full-story on the screen, or the user may prompt the mirror to push the story to a second device. For example, a user may present a mobile device to the mirror, which may queue the mirror to push the article corresponding to a particular headline to the mobile device. The interaction between the mobile device and the mirror may be enabled by the RFID reader of an Near Field Communication (“NFC”) interaction point, BlueTooth interaction, or other similar proximity-based protocol. Video content may also be displayed on the mirror.

Other devices may also be integrated with the data-bearing mirror. For example, a user may wear a sensor (or use a mobile device) that tracks exercise, activity level and/or other action of a user during a day or other time period. The sensor may communicate with the data-bearing mirror to transmit the activity level information, which may in turn be displayed to the user on the data-bearing mirror's screen. The data-bearing minor may also process the data to develop various charts, graphics and/or analysis based on the inputted data. The data-bearing mirror may integrate behavior data received from the sensor to pull content from the internet related to the inputted data. For example, highly active users may be presented with advertisements from sportswear companies. Less active people may be presented with advertisements directed towards gym memberships or health-related activities. It should be appreciated that this example is exemplary only, and that the data-bearing mirror may present a user with any type of customized content in response to various types of user or data inputs.

The data-bearing mirror may also comprise an RFID-enabled shelf that is capable of responding to objects that are placed on it, including, for example, medications and personal care products. When such objects are placed on the RFID-enabled shelf, the data-bearing mirror may present informative and/or personalized data related to the objects.

The data-bearing mirror may be connected to a network, such as the internet. In exemplary embodiments, the mirror may be used to schedule events on a personal calendar, shop online, exchange messages with users of other network-connected devices and/or perform other interactions. The data-bearing mirror is also capable of delivering traditional forms of content via its screen functionality.

In other exemplary embodiments, the data-bearing mirror may be configured to provide video messaging with users of other network connected devices. In other exemplary embodiments, a user may interface with the mirror using a mobile device having an application that is synched with the content displayed on the data-bearing mirror. For example, if the user is looking at the mirror and the mirror's facial recognition has misidentified the user's face, the application on the mobile device may communicate with the data-bearing minor to access user-specific content. It should be generally appreciated that a mobile device may configure the data-bearing mirror for a specific user, such that phone prompts (or facial recognition) may provide access to user-specific content such as social media accounts, calendar accounts, news feeds, etc.

In various exemplary embodiments, the data-bearing mirror may use facial recognition technology to call up personalized data, including health stats, a calendar, news feeds, and other information relevant to a particular user. The mirror may present customized information to the user automatically upon identifying the user's face. Moreover, the data-bearing mirror may also be configured to recognize certain personal behaviors and provide customized information to a user. For example, when a user schedules a trip or fails to get enough exercise, the user may be prompted with contextually-relevant content (e.g., weather conditions in the destination country or diet tips).

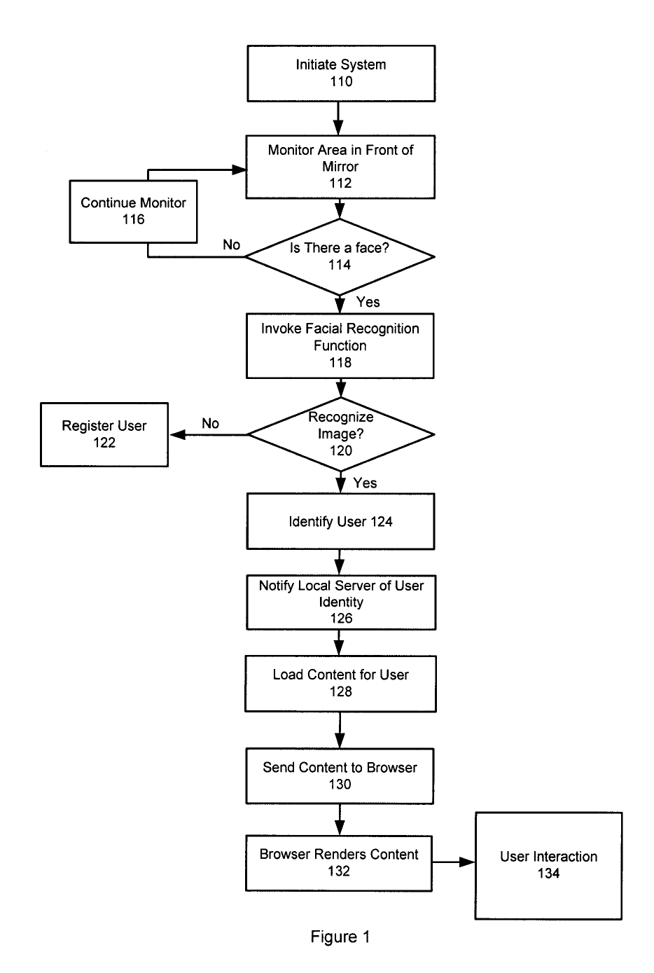

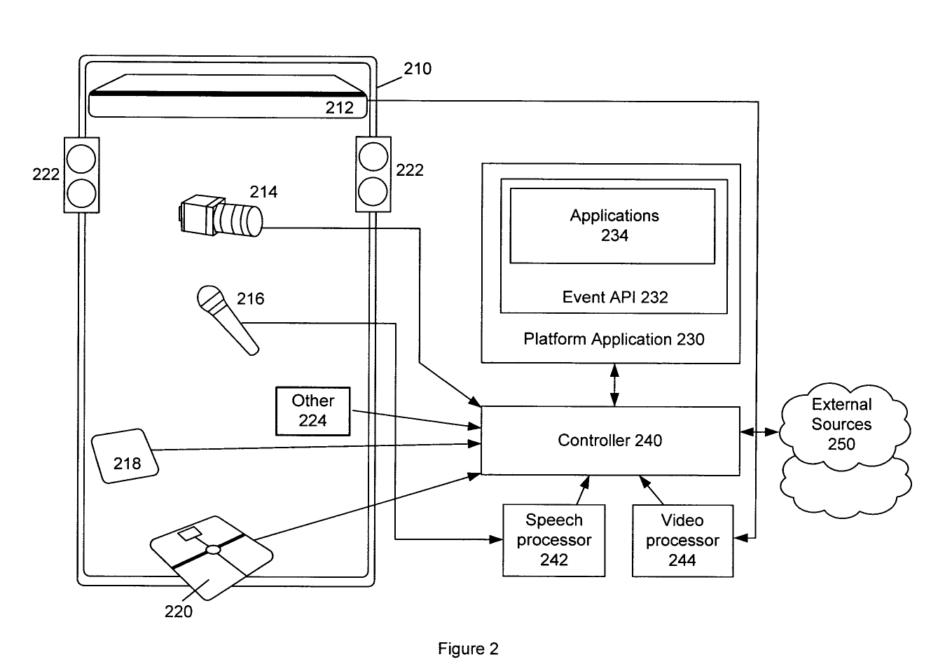

FIG. 1 is an exemplary method for implementing an interactive data-bearing mirror interface, according to an embodiment of the present invention. At step 110, the interface may be initiated. At step 112, the interface may monitor an area in front of the interface. At step 114, the interface may determine whether there is a person in front of the interface. If no, the interface may continue to monitor the area, at step 116. If yes, the interface may invoke a face recognition function at step 118. At step 120, the interface may determine whether it can recognize the face. If no, the interface may register the new user and associate an identity with the new user at step 122. If yes, the interface may identify the user at step 124. At step 126, the interface my notify a local server of the user's identity. At step 128, the local server may then load content associated with the identified user. At step 130, the content may be sent to a browser. At step 132, the browser may render the relevant content for the identified user. At step 134, the user may interact with the content displayed on the interface. The order illustrated is merely exemplary, other sequences of the steps illustrated may be realized. Additional steps may be added, and any one of the steps may be removed. This method is provided by way of example, as there are a variety of ways to carry out the methods described herein. Method 100 shown in FIG. 1 may be executed or otherwise performed by one or a combination of various systems. The method 100 may be carried out through system 200 of FIG. 2 by way of example. Each block shown in FIG. 1 represents one or more processes, methods, or subroutines carried out in method 100.

At step 110, the data-bearing interface may be initiated or otherwise activated. The user may initiate the interface by gesturing, swiping or otherwise interacting with the interface. Other forms of input may be accepted. The interface itself may be a mirror or other reflective surface. The interface may have various configurations, shapes, layouts, etc. The interface itself may be decorative or functional. For example, the interface may display a decorative image until a user is recognized and interaction is made available on the interface. Interface may function as a mirror, located above a bathroom sink, along a wall, next to a closet, etc. The interface may be located in a residential, private, corporate, public and/or other area. For example, the interface may be placed in a person's home, restricted areas, schools, companies, government locations as well as store location, shopping centers, malls, transmit stations, airports, etc.

At step 112, the interface may monitor an area in front of the interface. The interface may include a sensor where the sensor may determine if there is a person in front of the interface. The sensor may be able to distinguish between humans, pets, toddlers, objects, etc. Also, the sensor may be able to distinguish between registered or otherwise identifiable users and unknown users. The sensor may include a motion detector and/or other detection or recognition system.

At step 114, the interface may determine whether there is a person in front of the interface. If no, the interface may continue to monitor for a person or object at step 116. If yes, the interface may invoke a facial recognition feature at step 118. In addition, the data-bearing mirror may also use other forms of recognition, such as voice recognition, handprint recognition, fingerprint recognition, retina scan, etc. Also, a user may be identified by an object, such as a mobile device and/or other identifier.

At step 120, the interface may determine whether it can recognize the face. If no, the interface may register the new user and associate an identity with the new user at step 122. If yes, the interface may identify the person at step 124. The interface may recognize multiple people. For example, each family member may have a separate profile so that when a member of the family engages the interactive mirror, personalized content and display preferences specific to that user may be provided. In the example where interface is at a public area, the user's identity may be recognized by a mobile device, for example. Also, the user may interact with the interface as a general user and push or download information from the interface to the user's device, without having to upload any personal data to the interface itself.

At step 126, the interface may notify a local server of the person's identity. At step 128, the local server may then load content associated with the identified person. For example, the identified person may have a profile with preferences. The profile may be generated using the interface. Also, the profile may be created and/or updated using a remote device, such as mobile device, computer, laptop, etc. The profile may load the user's preferred background, applications, etc.

For example, during a user registration session, the user may provide a name or other identifier, including preferred location and/or other personal information, such as social media identifier, email address and/or other associated information. Also, the system may extract personal information from a user device, such as a mobile device.

At step 130, the content may be sent to a browser. For example, if the identified user engages the mirror in the morning, the user's profile may indicate that the user wants to view traffic, weather, top news, etc. on the interface. As the user is getting ready, the mirror may display a traffic report. The mirror may also indicate the current weather and projected forecast. If the user has loaded images and/or other data, the mirror may even suggest what the user could wear that day to work, depending on the weather. The interface may have access to the user's calendar and provide suggestions, e.g., traffic routes, etc., based on the activities for the day.

At step 132, the browser may render the relevant content for the identified person. The information displayed to the user may be presented based on the user's preferences. For example, a user may prefer audio information while another user may prefer images displayed on the left top corner of the interface. Also, the user may view social media information along a scrolling ticker displayed across the top of the interface, or along the side of the interface.

At step 134, the person may interact with the content displayed on the interface. Interaction with the mirror may include various forms of communication, including speech, gesturing, motion detection, touch, eye scan, etc. For example, the user may use voice commands, such as “Mirror, show me the weather.” The user may also use gestures, such as waving a hand to move to the next image or content. A menu of icons may be displayed along the bottom of the interface (or other location) where the user may gesture, point or otherwise select an icon to open or engage. The user may also type inputs from another device, such as a mobile phone, remote keyboard, virtual keyword, etc. The user may also provide inputs or movements by using a mouse, pointer, stylus and/or other interactive device or component.

The interface may synchronize data with other devices associated with the user. A synchronization command may be initiated from the interface and/or user device. Also, the user may dock, connect and/or communicate a user device with the interface. Doing so may initiate a synchronization option. The interface may provide access to data, applications, programs and/or other information on the user device. Also, the interface may synchronize with select applications, where only the calendar and a few select applications are synchronized. Other user preferences and variations may be realized.

FIG. 2 is an exemplary system for implementing an interactive data-bearing interface, according to an embodiment of the present invention. As shown in FIG. 2, minor 210 may be connected to various components. The components may be integrated as part of the mirror. The components may also be added by various connections, including a wire connection, a wireless connection and/or other form of connection. Some of the exemplary components may include a motion detector 212, a camera 214, a microphone 216, a sensor 218, a scale 220, and one or more speakers 222. The components may be located at various sections of the mirror 210. For example, multiple speakers may be located at the sides, at the corners, around the edges of the mirror and/or other locations. The camera 214 may capture and display images as well as provide video playback and capture functionality.

Mirror 210 may include a controller 240 for receiving inputs, processing the data and/or transmitting the processed data in various forms of output. Controller 240 may include a processor and support a platform application 230, which may include an event API 232 and other applications 234. Controller 240 may be communicatively coupled to various processors, including a speech processor 242, a video processor 244 and/or other processors. Speech processor 242 may receive inputs from microphone 216, and video processor 244 may receive inputs from game controller 212, camera 214 and/or other components. Camera 214 may receive and/or send images, video and/or other data. Controller 240 may also receive inputs from sensor 218, scale 220 and/or other input device 224. In addition, controller 240 may be connected to various external sources of data 250, including social media sources, content providers, advertisers, merchants, service providers, financial institutions, educational entities, employers, and/or other sources of data. Controller 240 may also receive information from a user's mobile device, phone, token, RFID, and/or other associated device. Controller 240 may communicate with various sources via data networks.

The data networks may be a wireless network, a wired network, or any combination of wireless network and wired network. For example, the data network may include any, or a combination, of a fiber optics network, a passive optical network, a radio near field communication network (e.g., a Bluetooth network), a cable network, an Internet network, a satellite network (e.g., operating in Band C, Band Ku, or Band Ka), a wireless local area network (LAN), a Global System for Mobile Communication (GSM), a Personal Communication Service (PCS), a Personal Area Network (PAN), D-AMPS, Wi-Fi, Fixed Wireless Data, IEEE 802.11a, 802.11b, 802.15.1, 802.11n and 802.11g or any other wired or wireless network configured to transmit or receive a data signal. In addition, the data network may include, without limitation, a telephone line, fiber optics, IEEE Ethernet 802.3, a wide area network (WAN), a LAN, or a global network, such as the Internet. Also, the data network may support, an Internet network, a wireless communication network, a cellular network, a broadcast network, or the like, or any combination thereof. The data network may further include one, or any number of the exemplary types of networks mentioned above operating as a stand-alone network or in cooperation with each other. The data network may utilize one or more protocols of one or more network elements to which it is communicatively coupled. The data network may translate to or from other protocols to one or more protocols of network devices. It should be appreciated that according to one or more embodiments, the data network may comprise a plurality of interconnected networks, such as, for example, a service provider network, the Internet, a broadcaster's network, a cable television network, corporate networks, and home networks.

Each illustrative block may transmit data to and receive data from data networks. The data may be transmitted and received utilizing a standard telecommunications protocol or a standard networking protocol. For example, one embodiment may utilize Session Initiation Protocol (SIP). In other embodiments, the data may be transmitted, received, or a combination of both, utilizing other VoIP or messaging protocols. For example, data may also be transmitted, received, or a combination of both, using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and systems suitable for transmitting and receiving data. Data may be transmitted and received wirelessly or may utilize cabled network or telecom connections such as: an Ethernet RJ45/Category 5 Ethernet connection, a fiber connection, a traditional phone wire-line connection, a cable connection, or other wired network connection. The data network 104 may use standard wireless protocols including IEEE 802.11a, 802.11b, 802.11g, and 802.11n. The data network may also use protocols for a wired connection, such as an IEEE Ethernet 802.3.

Controller 240 may include, but is not limited to, a computer device or communications device. For example, controller 240 may include a personal computer (PC), a workstation, a mobile device, a thin system, a fat system, a network appliance, an Internet browser, a server, a lap top device, a VoIP device, an ATA, a video server, a Public Switched Telephone Network (PSTN) gateway, a Mobile Switching Center (MSC) gateway, or any other device that is configured to receive, process and display interactive data via controller 240.

The data paths disclosed herein may include any device that communicatively couples devices to each other. For example, a data path may include one or more networks or one or more conductive wires (e.g., copper wires).

Controller 240 may include computer-implemented software, hardware, or a combination of both, configured to receive, process and display interactive content from various sources of data. External sources may include a publisher, news source, online magazine, may set up lists of the articles, pages, or other content items. A content item may include any, or a combination, of electronic content, digitally published newspaper articles, digitally published magazine articles, and electronic books. Other examples of content items may include video, audio, images and/or other electronic information. Accordingly, aggregated content from multiple content providers may be available to subscribers, advertisers, marketers and other interested entities. The aggregated content may be accessible via a network connection. Content may be provided by a single source or multiple sources.

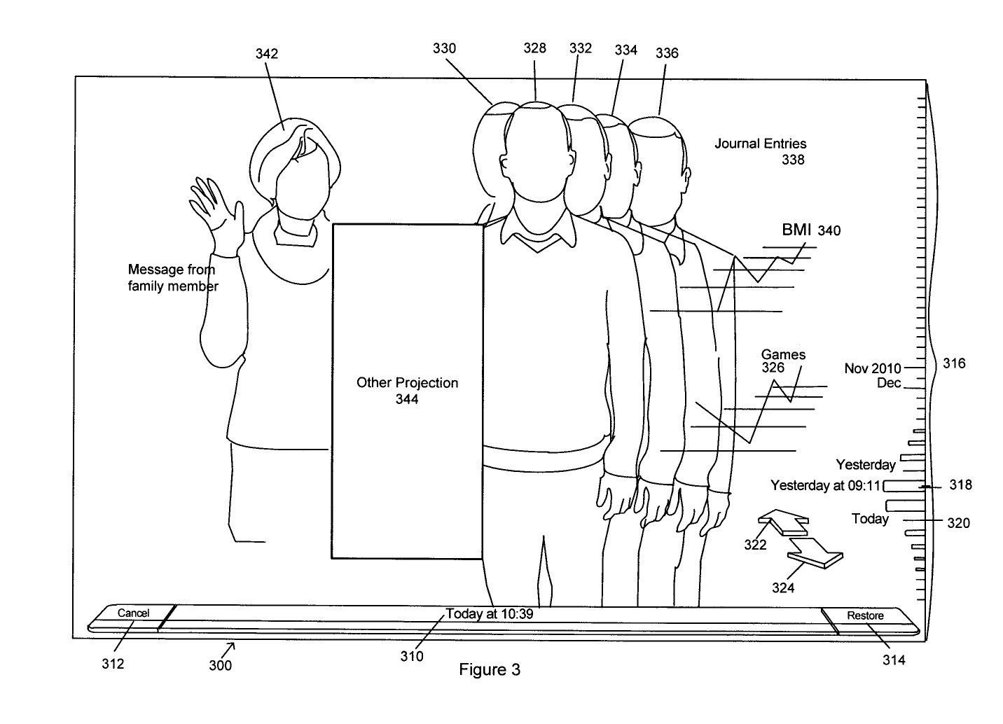

FIG. 3 is an exemplary display illustrating an interactive data-bearing interface, according to an embodiment of the present invention. Interface 310 illustrates exemplary functions in accordance with the various embodiments of the present invention. An interactive tool bar may be displayed along the bottom of the interface. The interactive tool bar may be displayed in various locations including the side of the interface, along the top, at the corners and/or other location. As shown here, 310 shows the current day and time. Other functionality may include cancel at 312 and restore at 314.

An interactive timeline may be displayed at 316, where the current day is shown at 320 and data from yesterday is shown at 318. The user may access information from past visits based on the day and/or time. While not shown, the user may also search using search terms by voice commands and/or other commands. Other interactive icons may be displayed, as shown by back 322 and forward 324. A user may also monitor time spent on various activities. In this exemplary illustration, a user's time spent on a popular game may be shown at 326. Other data, statistics, historical information may be stored and displayed at the user's request and/or based on preference data.

A user's current image may be displayed at 328. A user's prior data and corresponding images may be displayed, as shown by 330, 332, 334 and 336. The metrics corresponding to past images may be stored and graphically displayed. For example, journal entries may be stored at 338 and a user's prior BMI data may available to the user at 340.

The interface may also support video conferences as well as record, store and play video messages, as shown by 342. An image, icon, message or other indicator may be displayed to the user to inform the user that a message is available. Also, other projections, information and/or data may be displayed at 344.

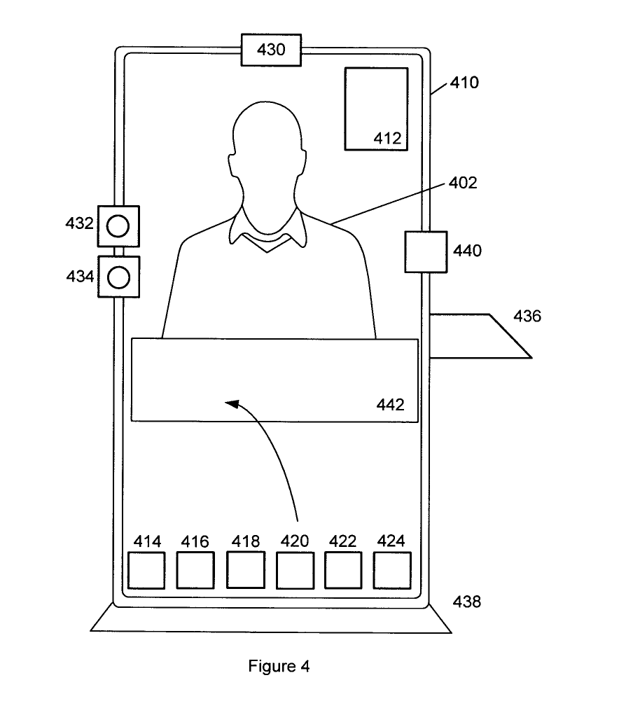

FIG. 4 is an exemplary display illustrating an interactive data-bearing interface, according to an embodiment of the present invention. Interactive interface 410 may have a reflective surface, such as a mirror, where icons, images, messages and/or other data may be overlaid on the mirror surface, as shown by interactive space 442. While the user is standing in front of the mirror, shown by mirror image 402, the interface may detect the user and display the user's face, image, identifier and/or other personal data at 412. The interface may display a menu of icons along the bottom of the interface. In this exemplary illustration, the icons may include Weather 414, Calendar 416, Health 418, News 420, and/or Social Media 422. The user may also check emails, send/receive text message and engage in other forms of communication at 424. The interface may include motion detector component 430, sensor 432 and microphone 434. One or more speakers, represented by 440, may be integrated at various locations along the interface. The interface may take on various forms, including other sizes and shapes.

The interface may be a bathroom mirror with a shelf or ledge where items may be placed and detected. In this example, the interface may include a shelf integrated along the bottom of the interface, as shown by lower shelf 438. The interface may also serve as a full length mirror in which case a side shelf may be provided for sensing objects, as shown by side shelf 436. Other shelves and/or other extensions may be implemented in various locations and forms. For example, a user may place a user device, such as a phone, on side shelf 436. When the user device is recognized, the interface may communicate to and/or from the user device.

The interface may also recognize objects by using a sensor, such as a RFID sensor. When placed at a predetermined location of the shelf, a sensor may recognize the object and display corresponding information. For example, when the interface is used as a bathroom mirror, the user's medication, pillow bottles, cosmetics, skincare and/or other object may be placed in front of the sensor. In response, the interface may display informative data. According to an exemplary application, the interface may provide medicine tracking/management features. For example, in the case of medication, information such as precautions, dosage, next doctor's appointment may be displayed. When multiple medications are sensed, the interface may serve to remind the user the next dosage for each medication, directions for use, possible side effects, potential interactions with other medications, vitamins, foods, etc. For cosmetics and/or skincare, the interface may display an image of the item and enable the user to easily purchase products, search for coupons, promotions and/or other incentives. The user may also place the item on a shopping list. The interface may suggest related products to the user. Suggestions for products may be automatically recommended, where the recommendations may be based on user specific information. Also, the interface may respond based on user input or request. According to another example, the user may request a search for a new product. The user may request “Mirror, I need a new sunscreen.” The interface may consider what products the customer is currently using and suggest a product, in this case sunscreen, that compliments the user's current regime and/or preferences.

According to an exemplary scenario, a user may view a headline of interest from News icon 420 and forward the full article to the user's mobile device. The headline and/or full content may be overlaid over the user's mirror image 402 and displayed at 442. Also, the full article may be simply transmitted electronically to an identified user device and/or recipient(s). For example, the user may say “Mirror, send to my phone” and also “Mirror, send to Jack and Kathy.”

Through the interface, the user may perform various functions available on a user's device, such as a mobile phone. For example, the user may voice text messages, compose emails and/or compose other forms of communication using the interface and transmit to various other devices. Also, the user may participate in video calls, including two or more participants. The user may also access applications, programs and/or other data available on another device and essentially serve as a portal or conduit to information stored in various locations and/or devices.

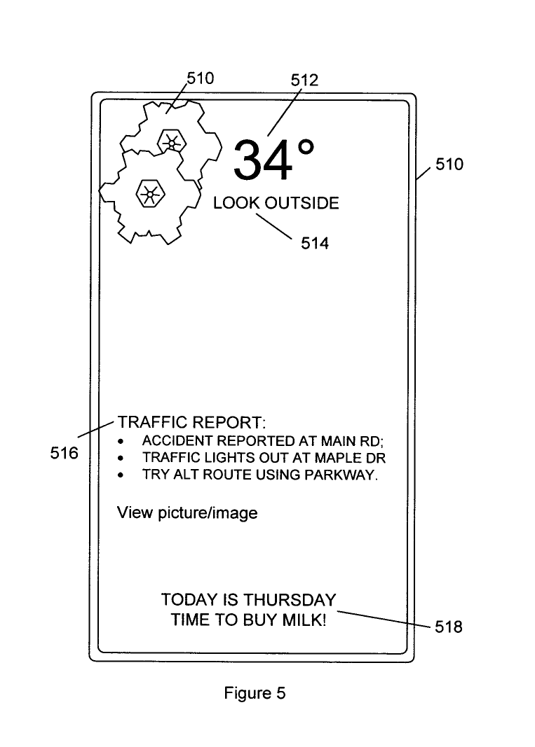

FIG. 5 is an exemplary display illustrating a weather feature on an interactive data-bearing interface, according to an embodiment of the present invention. Interface 510 may display current weather information. In this exemplary illustration, an icon indicative of the current weather conditions may be displayed. In this case, a snow flake is shown at 510. Current temperature may be shown at 512. The user may also be given the option to view actual weather conditions by selecting a “look outside” feature at 514. For example, the user may use a voice command, such as “Mirror, show weather outside” where an image of current weather conditions may be displayed on a portion, or an entirety of the interface. Other variations may be realized. For example, a user planning a trip to a different part of the country may be interested in the weather conditions at that city. In this case, at a different corner or section of the mirror, a user currently in New York City may also view weather conditions in San Francisco, including an extended forecast of that area. Also, a user may view hourly weather data and forecasted data for current conditions as well as other areas. In other instances, a user may be concerned with severe weather conditions and request detailed weather updates, storm tracker maps and/or other timely information.

The interface may also provide commuting information 516, such as traffic reports, images from the user's commuting route, suggestions for alternate routes, public transportation information (e.g., train/bus delays, next train/bus arrival information, etc.). On days that the user is traveling by plane, flight information may be provided. The user may provide commuting information (e.g., what route the user takes to get into the office, etc.) and the interface may respond with relevant traffic information. If the user drives to work, relevant traffic information along the user's regular commuting route may be provided. If traffic is particularly bad, the interface may suggest other routes and estimated arrival times.

According to another embodiment of the present invention, a user may view a to-do list, shopping list and/or other reminders. In the example shown in FIG. 5, a user is reminded that it's time to buy milk, shown at 518. The to-do list may be displayed as the user inputs information into the interactive interface. For example, the interface may use a speech recognition function to capture the user's verbal instructions and display the text. According to another example, user may script or type a list into the interface itself. For example, a keyboard or keypad may be connected or communicatively coupled to the interface for user input. Also, the to-do list may be extracted from a mobile device or other device comprising a processor. The user may also add items to the list while the user is browsing and also save images and links to the list.

According to another example, the interface may convert a portion of the interface, a designated area and/or the entire interface into a chalkboard type of interface that allows a user to script or otherwise input notation or other information. The information may be saved as part of the image, the information may also be converted into another script for display.

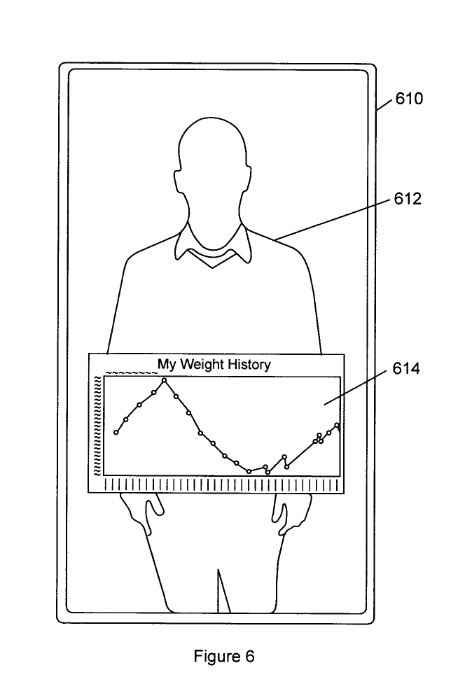

FIG. 6 is an exemplary display illustrating a health monitoring feature on an interactive data-bearing interface, according to an embodiment of the present invention. An embodiment of the present invention may extract, store, process, manipulate and/or graphically display various forms of biometric information. Interface 610 may take an image of the user at 612. Historical information may be displayed at 614. In this example, a user's historical weight information may be shown in a graphical format. A scale or other device capable of detecting a user's weight as well as other physical characteristics may detect the information. By stepping on the scale, the interface may take a photo of the user. Also, the user may manually enter data, via text input, voice recognition (e.g., by saying the user's current weight), etc. An embodiment of the present invention enables a user to manage weight loss and/or weight gain. For example, a user may enter a weight loss goal and the biometric feature of an embodiment of the present invention may help the user reach that goal. The user may also view prior images to assess progress. Prior images may be accessed by verbally requesting the images, gesturing, scrolling and/or other form of input. According to another example, a pregnant woman may use the biometric feature to monitor healthy weight gain and progress. Weight and height may be monitored for young children. Before and after images may be taken. Another feature may include vocal commentary that may provide various types of information, including progress, encouragement, advice, etc. In addition, relevant content may be displayed for the user's consideration. For example, as the user is viewing weight loss progress, a headline for healthy recipes may be displayed. If the user is interested in the full article, the user may save the full article to a user device for viewing at a later time. Relevant content may also include videos, articles, and/or other content. Data may be merged with other applications. For example, a user may want to upload images, data, graphics to a social media site or other website to share the progress with friends.

Other applications for the health monitoring feature of an embodiment of the present invention may be realized. For example, the biometrics feature may be used by physicians to monitor and track how a patient is responding to medication and/or treatment. Also, a patient may monitor his or her own progress at home using the biometrics feature of an embodiment of the present invention. A user may also want to see if a certain product is making a noticeable difference. For example, the user may monitor the progress of a new skincare line by taking images of the user every night and then view results over a two month time frame.

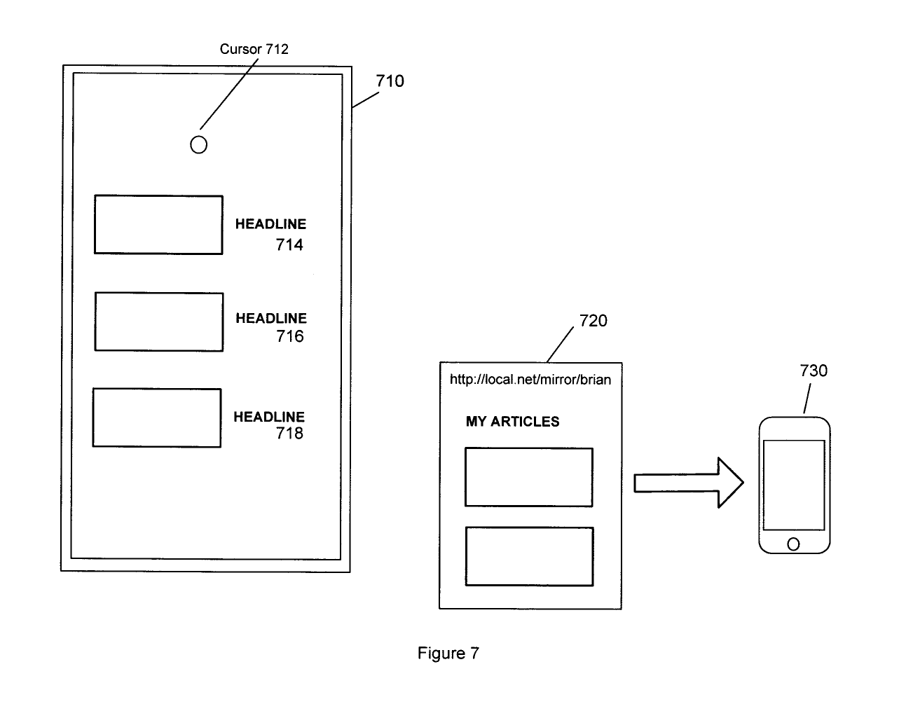

FIG. 7 is an exemplary display illustrating a content display on an interactive data-bearing interface, according to an embodiment of the present invention. Interface 710 may display various headlines with or without images for top news stories, as shown by 714, 716 and 718. A headline may be selected by voice command, using a cursor 712 via motion detection and/or other form of input. By selecting the headline, full content may be display. Also, a user may use a grab gesture to save the full content version to a list of saved articles at 720 and then push the articles to a user's mobile device 730. Other gestures and movements may invoke other actions, e.g., delete, next, save, etc. The user may indicate a preference for content source (e.g., New York Times), type of articles (e.g., college football), keywords (e.g., weather), and/or other preferences. In addition, a user's profile may indicate preferences for news content and may be updated by the user. Also, content information may be synchronized with the user's computer, mobile phone and/or other device.

The interface may also include an alarm or timer feature where an alarm sound, music and/or other sound is used. Also, the interface may include a flash feature that periodically flashes to alert the user.

The interface may be connected to various forms of social networking websites, including microblogging sites, social media sites, image aggregators and/or other forms of user generated content networking sites. For example, a feed that provides latest updates, posts, comments, likes, and/or other user generated content may be displayed and/or scrolled. Multiple social networking sources may provide separate feeds. Also, multiple sources may be aggregated together as a single feed and/or display. The feed may display the social media information on a scrolling basis, the feed may also be displayed as a ticker along a side of the interface. Other displays and configurations may be realized.

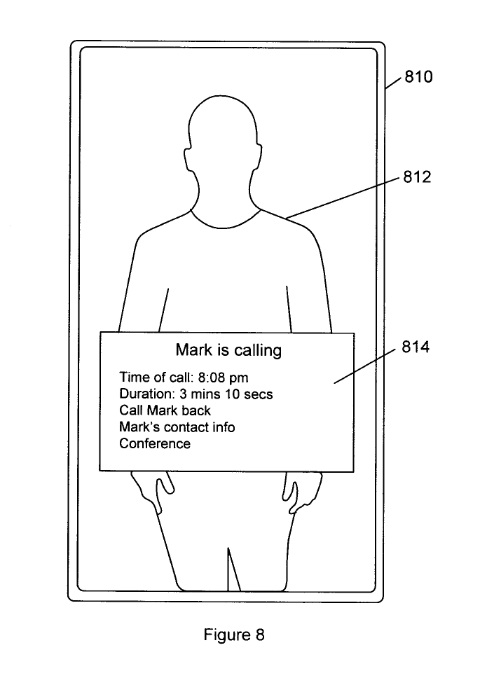

FIG. 8 is an exemplary display illustrating a video messaging on an interactive data-bearing interface, according to an embodiment of the present invention. A video feature may be provided where users may make video calls to a user with an interactive interface. Also, the video feature may also connect to other devices, including computer, mobile devices, video phone, etc. Also, video messages may be sent and stored at the interface 810 and displayed at 812. In this example, information related to the call and the caller may be displayed at 814. A user may leave a video message for another user on the same interface. For example, a parent may leave a message for his child in the morning where the child can play the message before she goes to school. The parent may leave a message that says “good luck on your test today.” Videos from other sources may be displayed on the interface. For example, a video of a child's music recital may be sent via email or text message, which may then be sent to the interface for display.

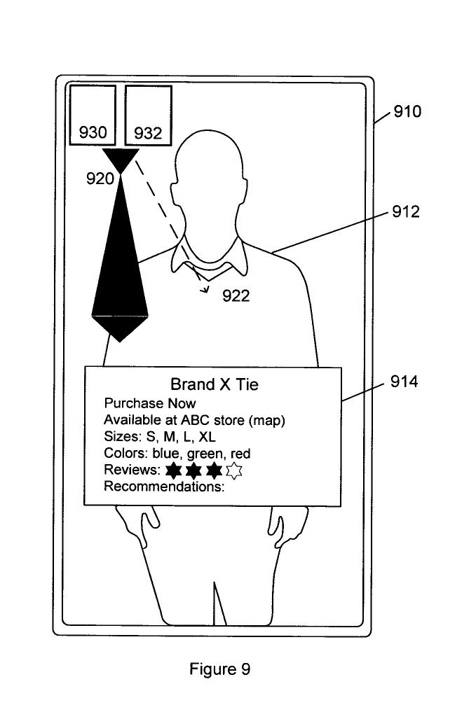

FIG. 9 is an exemplary interface illustrating a clothing application, according to an embodiment of the present invention. A clothing preview feature may be provided at the interface, shown by 910. For example, a user upload an image of an article of clothing and virtually “try on” the outfit. The image may be from a retailer or other online source. The article of clothing image may be an image from the user's closet or other source. The user may overlay an image of the article of clothing over the user's current image on the interface, e.g., mirror image. For example, an image of a tie 920 may be placed on the user's image 912. In this example, the interface identifies where the user's face is and positions the tie at a location appropriate for the tie, as shown by 922. Based on the type of clothing, the interface may accurately identify where the clothing should be placed. The interface may resize the article of clothing so that it “fits” on the image of the user. Details about the article of clothing may be displayed at 914. Purchase information may be displayed so that the user may easily purchase the item. The user may also take images of articles of clothing from the user's current closet. The user may try on images from friend's closest and/or other sources. Prior images may be shown at 930, 932. The user may also “try on” accessories, belts, hats, coats, shoes, etc. These images may then be stored and retrieved. This may also be a way for the user is maintain inventory in the user's closet. The interface may further suggest outfits and/or articles of clothing to wear by matching color and/or other criteria. The suggestions may be based on prior outfits and images, weather, activities and/or other relevant data. Relevant content may also be presented, including articles from fashion magazines, celebrity news, and/or images from the user's favorite stores, designers, celebrities, etc. Also, an embodiment of the present invention may provide suggestions based on user profile information, e.g., body type, clothing preferences, budget, etc. For example, a user may want suggestions on how to update the user's current wardrobe with affordable accessories.

An embodiment of the present invention may also provide marketing opportunities for service and/or product providers. For example, personalized coupons, prepaid vouchers, rewards and/or other incentives may be provided on the interface. The user may select a coupon by saving it to the user's mobile device for presentment at the next purchasing opportunity.

Other applications may include viewing personal banking information, credit card spend, savings information, investment and portfolio information as well as other financial data.

The user may also control home appliances and features, such as dim lights, heat shower water, close garage door, set the alarm, heat the house, monitor a room, etc.

An embodiment of the present invention may be realized as a projection where the interactive content may be displayed at various surfaces, e.g., walls, ceiling, pavement, side of buildings, etc. The interface may display a hologram or three dimensional images. Other variations may be realized.

The previous description is intended to convey an understanding of the embodiments described by providing a number of exemplary embodiments and details involving systems, methods, and devices related to a data-bearing mirror. It should be appreciated, however, that the present invention is not limited to these specific exemplary embodiments and details. For example, the various embodiments described above may incorporate any sort of display and should not be construed to be limited to a mirror or other reflective surface. It is further understood that one possessing ordinary skill in the art, in light of known systems and methods, would appreciate the use of the invention for its intended purposes and benefits in any number of alternative embodiments, depending on specific design and other needs.

The description above describes elements of a network that may include one or more modules, some of which are explicitly shown in the figures, others that are not. As used herein, the term “module” may be understood to refer to computing software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

The description below also describes physical and logical elements of a network and/or a system, some of which are explicitly shown in figures, others that are not. The inclusion of some physical elements of a network and/or a system may help illustrate how a given network and/or system may be modeled. It should be noted, however, that all illustrations are purely exemplary and that the network and/or system scheme described herein may be performed on different varieties of networks and/or systems which may include different physical and logical elements.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof.

Although this invention has been described with reference to particular embodiments, it will be appreciated that many variations may be resorted to without departing from the spirit and scope of this invention. Also the system of the present invention may be implemented over a local network or virtual private network or any internet worked system, and is not limited to the Internet.

1. An interactive interface, comprising:
a mirror surface;
a sensor configured to receive an input from a user;
a processor communicatively coupled to the sensor; the processor configured to identify a user identification based on the input, retrieve user specific content associated with the user identification; and identify one or more interactions with the user, wherein the processor comprises a speech processor and a video processor; and
an output configured to display content associated with the user identification and responsive to the interactions on the mirror surface.

2. The interactive interface of claim 1, wherein the sensor comprises a voice sensor.

3. The interactive interface of claim 1, wherein the sensor comprises a motion detector.

4. The interactive interface of claim 1, wherein the processor is configured to process data from external content provider sources.

5. The interactive interface of claim 1, comprises a memory configured to store the one or more interactions with the user and user profile data associated with the user.

6. The interactive interface of claim 1, comprises an shelf extension comprising a shelf sensor, the shelf sensor configured to identify one or more objects placed on the shelf extension.

7. The interactive interface of claim 1, wherein the output overlays interactive content over a mirror image of the user.

8. The interactive interface of claim 1, wherein the one or more interactions relate to one or more of: weather functionality, biometrics functionality, calendar functionality, news content functionality, and social media functionality.

9. The interactive interface of claim 1, comprising an interface communicatively coupled to a mobile device associated with the user.

10. The interactive interface of claim 1, wherein the processor is configured to enable the user to make online purchases based on the content displayed on the output.

11. A method for interacting with a data-bearing interface, comprising the steps of:
detecting, via a sensor, a user in an area proximate to a mirror surface of the data-bearing interface;
identifying, via a recognition processor coupled to the sensor, the user by recognizing a physical attribute of the user;
identifying, via a controller processor, a user identifier associated with the user;
displaying, on the mirror surface, user specific content associated with the user identifier;
interacting, via the motion sensor, with the user by one or more commands; and
displaying, on the mirror surface, content responsive to the one or more commands.

12. The method of claim 11, wherein the recognition processor comprises one or more of: a facial recognition module and a voice recognition module.

13. The method of claim 11, wherein the sensor comprises a motion detector.

14. The method of claim 11, wherein the content responsive to the one or more commands comprises content from external content provider sources.

15. The method of claim 11, further comprises the step of:
storing the one or more commands with the user.

16. The method of claim 11, wherein the content responsive to the one or more commands is overlaid over a mirror image of the user.

17. The method of claim 11, wherein the one or more interactions relate to one or more of: weather functionality, biometrics functionality, calendar functionality, news content functionality, and social media functionality.

18. The method of claim 11, further comprising the step of:
forwarding content to a mobile device in communication with the data-bearing interface.

19. The method of claim 11, further comprising the step of:
purchasing one or more items displayed on the mirror surface.

20. The method of claim 11, wherein the one or more commands comprise one or more of: voice commands and motion commands.
